(19) United States
(12) Patent Application Publication
(10) Pub. No.: US 2026/0093088 A1
(43) Pub. Date: Apr. 2, 2026

(54) IMAGING LENS

(71) Applicant: Changzhou AAC Raytech Optronics Co., Ltd., Changzhou City (CN)

(72) Inventor: Jin Li, Changzhou (CN)

(21) Appl. No.: 18/979,701

(22) Filed: Dec. 13, 2024

Related U.S. Application Data
(63) Continuation of application No. PCT/CN2024/122703, filed on Sep. 30, 2024.

(51) Int. Cl. G02B 7/02; G02B 5/00

(52) U.S. Cl. CPC G02B 7/025; G02B 5/003; G02B 7/021

(57) ABSTRACT

An imaging lens is provided and includes a lens barrel and a plurality of lenses received in the lens barrel. The plurality of lenses include at least a first lens and a second lens arranged sequentially from an object side to an image side, where the second lens has an outer diameter 1.1 times or more than an outer diameter of the first lens, and the first lens is fixedly connected to the lens barrel by first fixing glue. The imaging lens of the present disclosure is suitable for the imaging lens with large difference in lens size, and the problem of yield reduction caused by deformation during lens assembly can be improved by gluing and fixing the lens with smaller lens size, so that the weight of the imaging lens is lighter and the cost is low.

### CROSS REFERENCE TO RELATED APPLICATIONS

The present application is a continuation of PCT Patent Application No. PCT/CN2024/122703, filed September 30, 2024, which is incorporated by reference herein in its entirety.

### TECHNICAL FIELD

The various embodiments described in this document relate in general to the technical field of optical imaging, and more specifically to an imaging lens.

### BACKGROUND

The imaging lens is an essential part of electronic devices (such as mobile phones). In some imaging lenses with ultra-small heads, due to structural limitations, the size of the head of the lens barrel is small and the size of the tail is large. The head refers to an end of the imaging lens close to the object side, and the tail refers to an end of the imaging lens close to the image side. Moreover, there is a large difference in outer diameters between at least two adjacent lenses. In the related technologies, when there is the large difference in the outer diameters of the two adjacent lenses, the bearing misalignment of the two lenses is relatively large. When assembled, the two lenses are easily deformed, thus affecting the optical performance of the imaging lens, and the assembly yield is also low.

In view of the problems existing in the related technologies, in the related technologies, auxiliary bearing limit is added to the lens with large deformation to improve the deformation of the lens. However, this manner requires cooperation of the lens barrel, the lens, and the light shielding sheet, and it is generally necessary to leave a certain gap in the auxiliary bearing limit to fit with the bearing structure of the lens barrel, which may merely improve the deformation of the lens to a certain extent. In addition, structure is relatively complicated. In the related technologies, there is a case where the bearing misalignment is disposed on a metal spacer having a high strength in order to improve the easy deformation of the lens. However, when the metal spacer is used, the weight of the imaging lens may be increased and the cost may increase. In addition, there is a high requirement for the metal spacer on the spacing between the two lenses. When the thickness of the metal spacer is thin, the strength may be small, and the lens may also be deformed if assembly misalignment of the lens is large to a certain extent, which may also reduce the assembly yield.

Therefore, it is necessary to provide a new imaging lens to solve the above-mentioned technical problems.

### SUMMARY

The present disclosure aims to provide an imaging lens, which aims to solve the problems that two adjacent lenses with large size difference in the small-head imaging lens in the related technologies are easy to deform and low yield.

In order to achieve the above object, embodiments of the present disclosure provide an imaging lens. The imaging lens includes a lens barrel and a plurality of lenses received in the lens barrel, and the plurality of lenses include at least a first lens and a second lens arranged sequentially from an object side to an image side of the imaging lens, where the second lens has an outer diameter 1.1 times or more than an outer diameter of the first lens, and the first lens is fixedly connected to the lens barrel by first fixing glue.

In some embodiments, the first lens includes an image side surface close to the image side, an object side surface close to the object side, and a connection surface connecting the image side surface and the object side surface, and the first fixing glue extends from the image side surface of the first lens to the connection surface of the first lens.

In some embodiments, the first lens and the lens barrel define a dispensing groove in a circumferential direction of the first lens, and the first fixing glue includes multiple sections spaced apart in the dispensing groove.

In some embodiments, the second lens is in interference fit with the lens barrel to achieve fixation of the second lens and the lens barrel.

In some embodiments, second fixing glue is further provided between the second lens and the lens barrel.

In some embodiments, the second lens has an outer diameter at least 0.5 millimeters larger than an outer diameter of the first lens.

In some embodiments, a lens in the plurality of lenses closest to the image side has an effective diameter twice or more than an effective diameter of a lens in the plurality of lenses closest to the object side.

In some embodiments, a light shielding sheet is provided between the first lens and the second lens.

In some embodiments, the imaging lens further includes a third lens provided on an object side of the first lens and a fourth lens provided on an image side of the second lens, where the fourth lens has an outer diameter 1.1 times or more than an outer diameter of the second lens, and the second lens is fixedly connected to the lens barrel by second fixing glue.

Compared with the related technologies, the present disclosure provides an imaging lens. The imaging lens includes the lens barrel and the plurality of lenses received in the lens barrel. The plurality of lenses include a first lens and a second lens arranged sequentially from the object side to the image side. The outer diameter of the second lens is at least 1.1 times the outer diameter of the first lens, and the first lens is fixedly connected to the lens barrel by the first fixing glue. In the imaging lens of the present disclosure, the small lens close to the object side in two adjacent lenses with large size difference is fixed by the fixing glue, and the large lens close to the image side is fixed by bearing and interference fit, which can greatly improve the problem of yield reduction caused by deformation during lens assembly, so that the weight of the imaging lens is lighter and the cost is low.

### BRIEF DESCRIPTION OF THE DRAWINGS

FIG. 1 is a schematic cross-sectional view of an imaging lens according to the present disclosure.

FIG. 2 is a schematic cross-sectional view of a partial structure in the imaging lens according to the present disclosure.

### DETAILED DESCRIPTION OF THE EMBODIMENTS

The technical solutions in the embodiments of the present disclosure will be clearly and completely described below in combination with the drawings in the embodiments of the present disclosure. Obviously, the described embodiments are only some embodiments of the present disclosure, rather than all embodiments. Based on the embodiments in the present disclosure, all other embodiments obtained by ordinary skilled personnel in the art without making creative effort belong to the scope of protection of the present disclosure.

The imaging lens of the present disclosure is especially suitable for small-head lens, a size of the head of the small-head lens is small and a size of the tail of the small-head lens is large. The head refers to an end of the imaging lens close to an object side, and the tail refers to an end of the imaging lens close to an image side. The size of the tail is generally twice or more than that of the head. There is a large difference between outer diameters of at least two adjacent lenses. This small-head lens is generally used in electronic devices such as mobile phones.

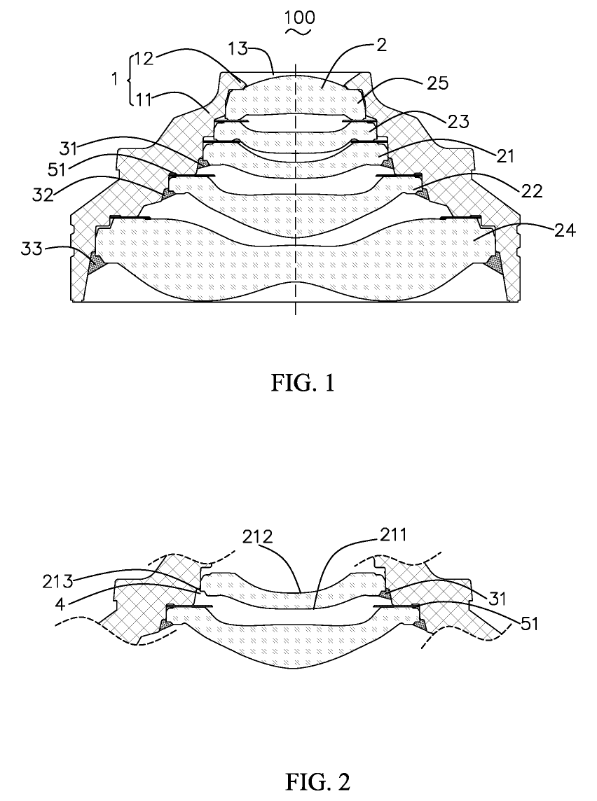

The present disclosure provides an imaging lens 100. The imaging lens 100 has an object side and an image side disposed opposite each other in a direction of an optical axis. As shown in FIGS. 1 and 2, the imaging lens 100 includes a lens barrel 1 and a plurality of lenses 2 received in the lens barrel 1.

The lens barrel 1 includes an annular barrel wall 11 and an extension wall 12 formed by bending and extending from an end of the barrel wall 11 close to the object side. The extension wall 12 defines a light passing hole 13. The barrel wall 11 has an irregular step shape in a direction from the object side to the image side, and gradually increases in size.

The plurality of lenses 2 includes at least a first lens 21 and a second lens 22 arranged in this order from the object side to the image side. An outer diameter of the second lens 22 is 1.1 times or more than an outer diameter of the first lens 21. Preferably, the outer diameter of the second lens 22 is between 1.1 times and 1.3 times the outer diameter of the first lens 21. In some scenarios, for example, in a mobile phone, the outer diameter of the second lens 22 is at least 0.5 millimeters larger than the outer diameter of the first lens 21. Since the size difference between the first lens 21 and the second lens 22 is large, the lens is easy to be deformed during assembly. The first lens 21 is fixedly connected to the lens barrel 1 by first fixing glue 31. That is, the small lens close to the object side in the two adjacent lenses having a large size difference, that is, the first lens 21 is bonded and fixed by the fixing glue, which can effectively improve the problem of lens deformation during assembly. The second lens 22 is in interference fit with the lens barrel 1 to realize fixation of the second lens 22 and the lens barrel 1. Furthermore, second fixing glue 32 may be provided between the second lens 22 and the lens barrel 1, so that the second lens 22 can be further fixed.

It shall be understood that the outer diameter of the lens refers to a maximum outer-contour diameter of the circular part of the lens. For a circular lens, the outer diameter refers to a length of a longest line segment that passes through the center of the lens and connects two points on the circumference of the lens. If the lens is square-shaped or of other shapes, the concept of the outer diameter may vary according to the actual situation. For example, for a square lens, the outer diameter may refer to a diameter of a circumcircle of the square lens, or a maximum length in a specific direction (such as a diagonal direction).

The first lens 21 includes an image side surface 211 close to the image side, an object side surface 212 close to the object side, and a connection surface 213 connecting the image side surface 211 and the object side surface 212. The first fixing glue 31 extends from the image side surface 211 of the first lens 21 to the connection surface 213 of the first lens 21. A dispensing groove 4 provided in a circumferential direction of the first lens 21 is formed between the first lens 21 and the lens barrel 1. The first fixing glue 31 includes a plurality of sections provided at intervals in the dispensing groove 4. With such configuration, a gap can be defined between the adjacent sections of the first fixing glue 31. When the imaging lens 100 is applied under high temperature and high humidity conditions, the gas in the imaging lens 100 expands, and the gap between the adjacent sections of the first fixing glue 31 can play a role of deflation in this case.

A light shielding sheet 51 is further provided between the first lens 21 and the second lens 22. The light shielding sheet 51 is not only used to absorb stray light generated between the first lens 21 and the second lens 22 and improve the imaging quality of the imaging lens 100, but also used to adjust a distance between the first lens 21 and the second lens 22.

In the present embodiment, the plurality of lenses 2 of the imaging lens 100 specifically includes five lenses 2, which sequentially include a first lens 21, a second lens 22 provided on an image side of the first lens 21, a third lens 23 provided on an object side of the first lens 21, a fourth lens 24 provided on an image side of the second lens 22, and a fifth lens 25 provided on an object side of the third lens 23 that are received in the lens barrel 1. For the three lenses of the first lens 21, the second lens 22, and the fourth lens 24, since the size difference between adjacent lenses is large, both the first lens 21 and the second lens 22 can be directly fixed to the lens barrel 1 by fixing glue. Specifically, in the present embodiment, the first lens 21 and the second lens 22 are preferably fixed by fixing glue, and the second lens 22 and the fourth lens 24 are fixed to the lens barrel 1 by interference fit. In order to further enhance the fixing effect, the fourth lens 24, that is, the lens closest to the image side, is further fixed by third fixing glue 33. Dispensing grooves that accommodate the first fixing glue 31 and the second fixing glue 32 are both annular structures, each of the first fixing glue 31 and the second fixing glue 32 includes a plurality of sections disposed in a corresponding dispensing groove, and a gap is provided between adjacent sections of the fixing glue. A glue dispensing groove accommodating the third fixing glue 33 has a whole circle structure, and the third fixing glue 33 is also a whole circle structure, thus providing good sealing performance of the entire imaging lens 100.

The light shielding sheet 51 is not only provided between the first lens 21 and the second lens 22, but also may be provided between any two other adjacent lenses in addition to the position between the first lens 21 and the second lens 22, which may depend on actual needs.

Regarding the above five lenses 2, an effective diameter of a lens (the fourth lens 24) closest to the image side is twice or more than an effective diameter of a lens (the fifth lens 25) closest to the object side. Preferably, in the present embodiment, the effective diameter of the fourth lens 24 is 2 to 2.5 times the effective diameter of the fifth lens 25.

It shall be understood that the effective diameter of the lens refers to an effective diameter range in which the lens actually participates in an imaging process in an optical system. The effective diameter determines a range through which light can pass through the lens and influences characteristics such as the quality and brightness of the imaging.

Compared with the related technologies, the present disclosure provides an imaging lens. The imaging lens includes the lens barrel and the plurality of lenses received in the lens barrel. The plurality of lenses include the first lens and the second lens arranged sequentially from the object side to the image side. The outer diameter of the second lens is at least 1.1 times the outer diameter of the first lens, and the first lens is fixedly connected to the lens barrel by the first fixing glue. In the imaging lens of the present disclosure, the small lens close to the object side in two adjacent lenses with large size difference is fixed by the fixing glue, and the large lens close to the image side is fixed by bearing and interference fit, which can greatly improve the problem of yield reduction caused by deformation during lens assembly, so that the weight of the imaging lens is lighter and the cost is low.

The above is merely the embodiments of the present disclosure, here it is to be pointed out that for ordinary skilled personnel in the art, without departing from the concept of creation of the present disclosure, improvements can also be made, but these belong to the scope of protection of the present disclosure.

What is claimed is:

1. An imaging lens, wherein the imaging lens includes a lens barrel and a plurality of lenses received in the lens barrel, and the plurality of lenses include at least a first lens and a second lens arranged sequentially from an object side to an image side of the imaging lens, wherein the second lens has an outer diameter 1.1 times or more than an outer diameter of the first lens, and the first lens is fixedly connected to the lens barrel by first fixing glue.

2. The imaging lens of claim 1, wherein the first lens includes an image side surface close to the image side, an object side surface close to the object side, and a connection surface connecting the image side surface and the object side surface, and the first fixing glue extends from the image side surface of the first lens to the connection surface of the first lens.

3. The imaging lens of claim 1, wherein the first lens and the lens barrel define a dispensing groove in a circumferential direction of the first lens, and the first fixing glue includes multiple sections spaced apart in the dispensing groove.

4. The imaging lens of claim 1, wherein the second lens is in interference fit with the lens barrel to achieve fixation of the second lens and the lens barrel.

5. The imaging lens of claim 4, wherein second fixing glue is further provided between the second lens and the lens barrel.

6. The imaging lens of claim 1, wherein the second lens has an outer diameter at least 0.5 millimeters larger than an outer diameter of the first lens.

7. The imaging lens of claim 1, wherein a lens in the plurality of lenses closest to the image side has an effective diameter twice or more than an effective diameter of a lens in the plurality of lenses closest to the object side.

8. The imaging lens of claim 1, wherein a light shielding sheet is provided between the first lens and the second lens.

9. The imaging lens of claim 1, wherein the imaging lens further comprises a third lens provided on an object side of the first lens and a fourth lens provided on an image side of the second lens, wherein the fourth lens has an outer diameter 1.1 times or more than an outer diameter of the second lens, and the second lens is fixedly connected to the lens barrel by second fixing glue.
